(19) United States
(12) Patent Application Publication
(10) Pub. No.: US 2026/0074249 A1
(43) Pub. Date: Mar. 12, 2026

(54) MULTI-MODULE FUEL CELL SYSTEM AND METHOD OF CONTROLLING THE SAME

(71) Applicants: Hyundai Motor Company, Seoul (KR); Kia Corporation, Seoul (KR)

(72) Inventors: Jae Gwang Lee, Hwaseong-Si (KR); Sung Gone Yoon, Hwaseong-Si (KR)

(21) Appl. No.: 19/201,279

(22) Filed: May 7, 2025

(30) Foreign Application Priority Data
Sep. 9, 2024 (KR) 10-2024-0122544

(51) Int. Cl. H01M 8/04858; B60L 53/53; B60L 53/54; H01M 8/04537; H01M 10/42; H01M 16/00

(52) U.S. Cl. CPC H01M 8/0494; H01M 8/04619; H01M 8/04626; H01M 8/04947; H01M 10/425; H01M 16/006; B60L 53/53; B60L 53/54; H01M 2220/20; H01M 2250/10; H01M 2250/402

(57) ABSTRACT

A multi-module fuel cell system includes a plurality of fuel cell stacks, at least one battery connected to the plurality of fuel cell stacks, and a controller configured to determine whether the plurality of fuel cell stacks and the at least one battery are allowed to provide outputs in response to input of a required output, and controls either the plurality of fuel cell stacks or the at least one battery, selectively, to provide an output to satisfy the required output based on a result of determination as to whether outputs are allowed to be provided, and a method of controlling the same.

### CROSS-REFERENCE TO THE RELATED APPLICATION

This application claims priority from Korean Patent Application No. 10-2024-0122544, filed on Sep. 9, 2024, in the Korean Intellectual Property Office, the disclosure of which is incorporated herein by reference in its entirety.

### TECHNICAL FIELD

The present disclosure relates to a multi-module fuel cell system that includes a plurality of fuel cell stacks and batteries, selectively drives the fuel cell stacks and batteries to provide power to the outside, and is applicable to an electric vehicle charging station, and a method of controlling the same.

### BACKGROUND

Recently, as distribution of electric vehicles (EVs) has increased, technology for EV charging stations has been developed. The EV charging stations need to store a large amount of electricity or receive electricity from outside. However, realistically, building such charging stations requires a lot of cost and infrastructure.

As a countermeasure, a plan to utilize fuel cells in electric vehicle charging stations has been considered. If fuel cells are utilized in electric vehicle charging stations, hydrogen may be used as an energy storage source, which is significantly effective.

However, such a charging station equipped with a plurality of fuel cell stacks to charge electric vehicles may have a problem that the stacks age or the system may become unstable due to inefficient control of the fuel cell stacks.

The matters described above as background technology are only intended to enhance understanding of the background of the present disclosure, and should not be taken as an acknowledgment that the matters correspond to conventional art already known to those of ordinary skill in the art.

### SUMMARY

The following summary presents a simplified summary of certain features. The summary is not an extensive overview and is not intended to identify key or critical elements.

Systems, apparatuses, and methods are described for a multi-module fuel cell system. A multi-module fuel cell system may comprise: a plurality of fuel cell stacks; at least one battery connected to the plurality of fuel cell stacks; and a controller configured to: determine, based on input indicating a requested power output and based on at least one of a state of charge (SoC) of the at least one battery or a number of fuel cell stacks in the plurality of fuel cell stacks, one or more of the plurality of fuel cell stacks or the at least one battery allowed to provide power output and selectively control, based on the determined one or more of the plurality of fuel cell stacks or the at least one battery allowed to provide power output, either at least one fuel stack of the plurality of fuel cell stacks or the at least one battery to output power to satisfy the requested power output.

A method of controlling a multi-module fuel cell system, comprising a plurality of fuel cell stacks and at least one battery, may comprise: determining, by a controller of the multi-module fuel cell system and based on input indicating a requested power output and based on at least one of a state of charge (SoC) of the at least one battery or a number of fuel cell stacks in the plurality of fuel cell stacks, one or more of the plurality of fuel cell stacks or the at least one battery allowed to provide power output; and selectively controlling, by the controller and based on the determined one or more of the plurality of fuel cell stacks or the at least one battery allowed to provide power output, either at least one fuel cell stack of the plurality of fuel cell stacks or the at least one battery to output power to satisfy the requested power output.

A multi-module fuel cell system may comprise: a plurality of fuel cell stacks; at least one battery; and a controller comprising: one or more processors; and a memory storing instructions that, when executed by the one or more processors, configure the controller to: monitor a state of charge (SoC) of the at least one battery and accumulated amounts of power output of each fuel cell stack of the plurality of fuel cell stacks; receive a request for power; and control, based on the request and whether the monitored SoC satisfies a SoC criterion, either: a fuel cell stack, of the plurality of fuel cell stacks and based on a corresponding accumulated amount of the monitored accumulated amounts, to satisfy the request, or the at least one battery to satisfy the request.

A method of controlling a multi-module fuel cell system, comprising a plurality of fuel cell stacks and at least one battery, may comprise: monitoring a state of charge (SoC) of the at least one battery and accumulated amounts of power output of each fuel cell stack of the plurality of fuel cell stacks; receiving a request for power; and controlling, based on the request and whether the monitored SoC satisfies a SoC criterion, either: a fuel cell stack, of the plurality of fuel cell stacks and based on a corresponding accumulated amount of the monitored accumulated amounts, to satisfy the request, or the at least one battery to satisfy the request.

These and other features and advantages are described in greater detail below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram illustrating a multi-module fuel cell system according to an example of the present disclosure;

FIG. 2 is a flowchart for describing a method of controlling the multi-module fuel cell system according to an example of the present disclosure;

FIG. 3 is a graph for describing an output flow of the multi-module fuel cell system according to an example of the present disclosure; and

FIG. 4 is a graph for describing battery pre-charging of the multi-module fuel cell system according to an example of the present disclosure.

### DETAILED DESCRIPTION

Hereinafter, examples of the present disclosure will be described in detail with reference to the attached drawings. Identical or similar components will be assigned the same reference numbers regardless of reference symbols, and duplicate descriptions thereof will be omitted.

If a detailed description of related publicly known technology may obscure the gist of the examples disclosed in the present specification, a detailed description thereof will be omitted. In addition, the attached drawings are only for easy understanding of the examples disclosed in this specification, and the technical idea disclosed in this specification is not limited by the attached drawings. Further, it should be understood that the present disclosure encompasses all changes, equivalents, and substitutes included in the spirit and technical scope of the present disclosure.

Although terms including ordinal numbers, such as “first”, “second”, etc., may be used herein to describe various components, the components are not limited by these terms. These terms are generally only used to distinguish one component from another.

A singular expression includes the plural form unless the context clearly dictates otherwise.

In the present specification, it should be understood that a term such as “include”, “comprise” or “have” is intended to designate that the features, numbers, steps, operations, components, parts, or combinations thereof described in the specification are present, and does not preclude the possibility of presence or addition of one or more other features, numbers, steps, operations, components, parts, or combinations thereof.

The suffixes “module” and “unit” for components used in the following description are given or used interchangeably only for the ease of preparing the specification, and do not have distinct meanings or roles in themselves.

When a component is referred to as being “coupled” or “connected” to another component, the component may be directly coupled or connected to the other component. However, it should be understood that another component may be present therebetween. In contrast, when a component is referred to as being “directly coupled” or “directly connected” to another component, it should be understood that there are no other components therebetween.

A controller may include a communication device that communicates with other controllers or sensors to control functions assigned thereto, a memory that stores operating systems or logic commands, input/output information, etc., and one or more processors that perform determination, calculation, decision, etc. necessary to control functions assigned thereto.

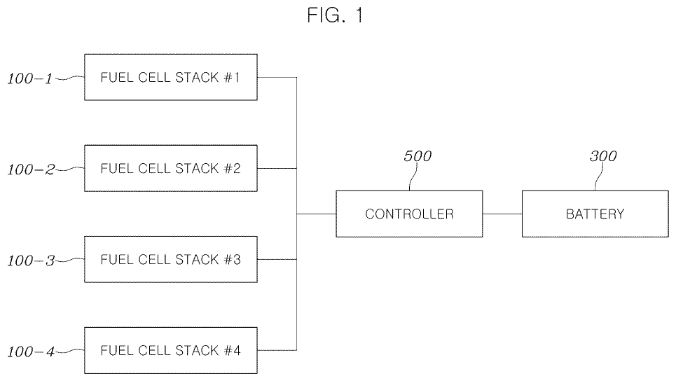

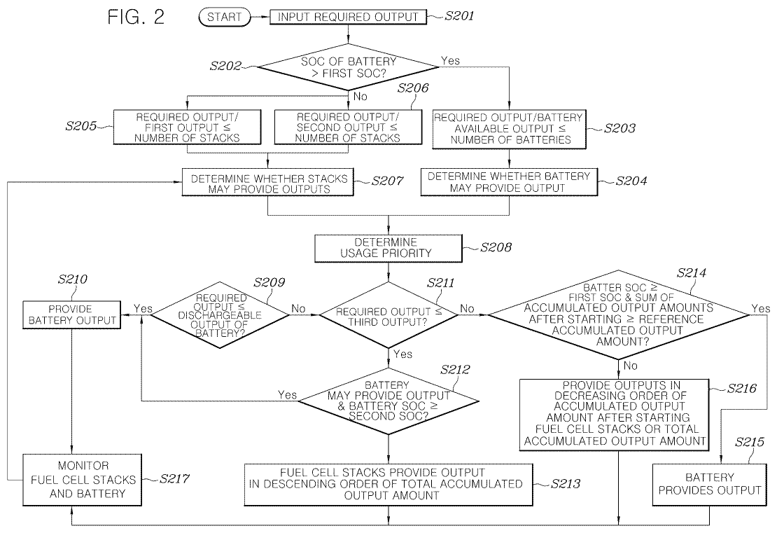

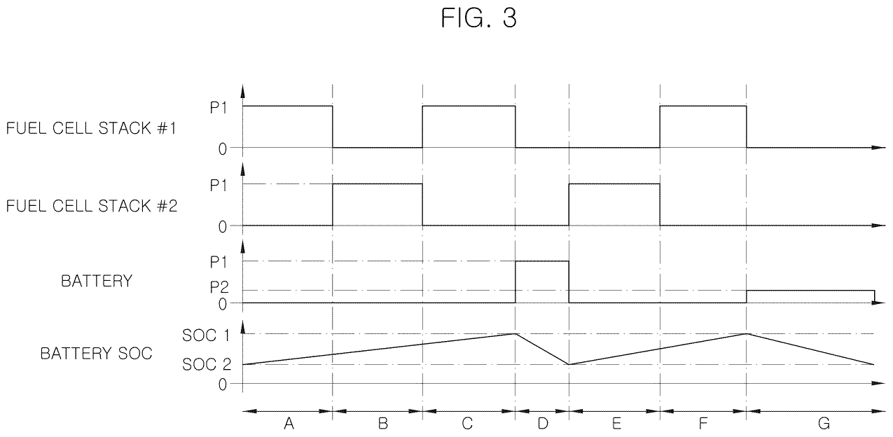

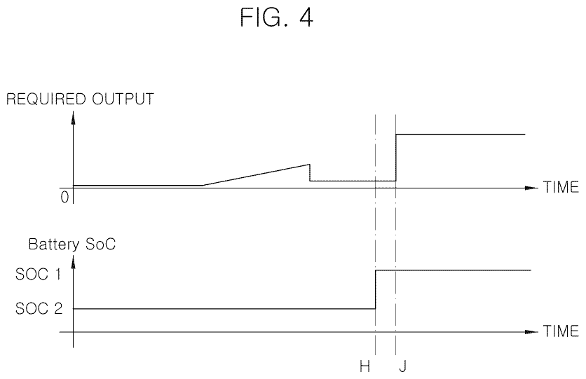

FIG. 1 is a diagram illustrating a multi-module fuel cell system according to an example of the present disclosure, FIG. 2 is a flowchart for describing a method of controlling the multi-module fuel cell system according to an example of the present disclosure, FIG. 3 is a graph for describing an output flow of the multi-module fuel cell system according to an example of the present disclosure, and FIG. 4 is a graph for describing battery pre-charging of the multi-module fuel cell system according to an example of the present disclosure.

Referring to FIG. 1, the multi-module fuel cell system according to the example of the present disclosure may include a plurality of fuel cell stacks 100-1, 100-2, 100-3, and 100-4, at least one battery 300, and a controller 500. FIG. 1 illustrates a configuration related to the example of the present disclosure, and it is to be understood that an actual multi-module fuel cell system may include more components. Also, or alternatively, while four fuel cell stacks 100-1, 100-2, 100-3 and 100-4 are illustrated and described in the example, any plurality of fuel cell stacks (e.g., any 2 or more fuel cell stacks) are encompassed by the present disclosure.

For example, the multi-module fuel cell system according to the example of the present disclosure may be applied to electric vehicle charging stations, and may be applied to industrial plants or buildings. Hereinafter, a case in which the multi-module fuel cell system is applied to an electric vehicle charging station will be described as a representative example.

The fuel cell system may be equipped with a fuel cell stack that produces electricity using hydrogen and air. The fuel cell stack produces electrical energy via a chemical reaction, and uses hydrogen as an energy source, so that there is an advantage of being able to sufficiently respond to sudden power demands.

However, since the fuel cell stack involves a chemical reaction, durability thereof is limited and efficiency of the fuel cell stack decreases during (e.g., each) initial startup, so that optimal control that takes durability and efficiency into account may be required.

Accordingly, the multi-module fuel cell system of the present disclosure may be equipped with the plurality of fuel cell stacks 100-1, 100-2, 100-3, and 100-4. Selectively operating the fuel cell stacks 100-1, 100-2, 100-3, and 100-4 according to a durability and/or deterioration state (state of health (SoH)) of each fuel cell stack may enable managed durability of each/all of the plurality of fuel cell stacks 100-1, 100-2, 100-3, and 100-4 (e.g., increase or even maximize durability).

Further, the battery 300 may be arranged to be connected to one or more of the fuel cell stacks 100-1, 100-2, 100-3, and 100-4. The battery 300 may be charged via a connected fuel cell stack of the plurality, and may respond to a small required output using the charge, preventing frequent starting/stopping of the fuel cell stack. Accordingly, the battery 300 may require individual control (e.g., via the controller 500) according to a state of the battery 300 (e.g., a state of charge (SoC) and/or temperature of the battery 300).

The controller 500 may control power provision/supply (e.g., to a vehicle comprising the multi-module fuel cell system) by controlling the plurality of fuel cell stacks 100-1, 100-2, 100-3, and 100-4 and/or the battery 300. For example, if the multi-module fuel cell system, according to the example of the present disclosure, is applied to an electric vehicle charging station, the controller 500 may provide power to a vehicle by controlling the plurality of fuel cell stacks 100-1, 100-2, 100-3, and 100-4 and/or the battery 300. The term “outside” in the present disclosure means various components that request power from outside the system of the present disclosure, such as a charger, a vehicle, an electrical device of a building, etc.

The battery 300 according to an example of the present disclosure may refer to a battery charged and/or discharged at high voltage. Even though FIG. 1 discloses that only one battery 300 is provided, this is an example, and one or more batteries 300 may be provided.

The controller 500 may receive (e.g., from the outside) input indicating a required output (where “required output” may be a desired and/or requested output indicated by the input). The controller 500 may control, based on the input, one or more of the plurality of fuel cell stacks 100-1, 100-2, 100-3, and 100-4 and the battery 300 to provide an output power to the outside. For example, the controller 500 may collect information about a state of each of the plurality of fuel cell stacks 100-1, 100-2, 100-3, and 100-4, a state of the battery 300, and/or the input (e.g., indicating a desired/required/requested output). The controller 500 may control the plurality of fuel cell stacks 100-1, 100-2, 100-3, and 100-4 and/or the battery 300 to provide an output satisfying the input and in consideration/based on the state of each of the plurality of fuel cell stacks 100-1, 100-2, 100-3, and 100-4 and/or the state of the battery 300. Also, or alternatively, the controller 500 may control only a subset (e.g., at least one) of the fuel cell stacks 100-1, 100-2, 100-3, and 100-4, and/or only the battery 300 to provide the output. Also, or alternatively, the controller 500 may control the battery 300 to be charged using the output of at least one fuel cell stack of the plurality of fuel cell stacks (e.g., as necessary).

The controller 500, according to an example of the present disclosure, may determine whether the plurality of fuel cell stacks 100-1, 100-2, 100-3, and 100-4 and/or the at least one battery 300 may provide outputs in response to input (e.g., of/for a required/desired output). The controller 500 may control the plurality of fuel cell stacks 100-1, 100-2, 100-3, and/or 100-4 and/or the at least one battery 300, selectively, to provide an output to satisfy the required output based on a result of determination as to whether the output may be provided, which will be described in detail with reference to FIG. 2.

Hereinafter, a method of controlling the multi-module fuel cell system according to an example of the present disclosure will be described with reference to FIG. 2.

FIG. 2 is a flowchart for describing the method of controlling the multi-module fuel cell system according to the example of the present disclosure, and a description will be given of the multi-module fuel cell system and specific control thereof according to an example of the present disclosure with reference thereto.

An input indicating a required power output may be received (S201). Based on the required output being input (e.g., from the outside) (S201), the controller 500 may determine whether the plurality of fuel cell stacks 100-1, 100-2, 100-3, and 100-4 and at least one battery 300 are able to provide outputs.

For example, the controller 500 may determine an SoC of the at least one battery 300, and compare the determined SoC of the at least one battery 300 with a first SoC preset to correspond to an upper limit of the battery SoC (S202). For example, the preset first SoC may be a value corresponding to 80% of the battery SoC. However, this is an example, and the present disclosure is not necessarily limited thereto. The controller 500 may determine whether the plurality of fuel cell stacks 100-1, 100-2, 100-3, and 100-4 and the at least one battery 300 may provide outputs based on a result of comparison between the SoC of the at least one battery 300 and the preset first SoC.

If the SOC of at least one battery 300 exceeds the first SoC (Yes in S202), the controller 500 may determine whether the at least one battery 300 may provide an output (S204) based on the number of the at least one battery 300, the input, and at least one among available output information of the at least one battery 300 (e.g., the available output information may be based on and/or comprise at least one of temperature information of the at least one battery 300, or SoC information of the at least one battery) (S203). For example, the controller 500 may divide the required output by a battery available output and compare a resultant value with the total number of batteries equipped in the system (S203). The controller 500 may determine whether the at least one battery 300 may provide an output based on the comparison result (S204). A reason for performing such a determination process may be to determine whether the required output requested from the outside may be handled only using the batteries included in the system.

The controller 500 may receive (e.g., be equipped with a data map that receives) input of a temperature (e.g., via a temperature sensor associated with the at least one battery 300) and/or an SoC of the at least one battery 300 (e.g., via a SoC sensor, such as a voltmeter). The controller 400 may determine, based on the input temperature and/or SoC whether an output (power) may be provided via the battery 300. For example, the controller 500 may output power to determine whether the battery is able to provide the output power. The controller 500 may determine whether the battery 300 may provide an output using the data map. In the data map, a current temperature and/or SoC of the battery 300 may be input, and a corresponding expected/predicted power from the battery 300 may be derived. The controller 500 may compare the derived power with the required output (e.g., indicated by the input in S201) to determine whether the battery 300 is able to provide an output.

If the SoC of the at least one battery 300 is less than or equal to the first SoC (No in S202), the controller 500 may determine whether the plurality of fuel cell stacks 100-1, 100-2, 100-3, and 100-4 may provide outputs based on a first output according to an output level, a second output greater than the first output, the number of the plurality of fuel cell stacks 100-1, 100-2, 100-3, and 100-4, and/or the required output (S205, S206, and S207). For example, the controller 500 may divide the required output by each of the first output and the second output greater than the first output, and compare each divided value with the number of the plurality of fuel cell stacks 100-1, 100-2, 100-3, and 100-4 provided in the system (S205 and S206). Then, the controller 500 may determine whether the plurality of fuel cell stacks 100-1, 100-2, 100-3, and 100-4 may provide outputs based on a comparison result (S207).

The controller 500 may determine that the plurality of fuel cell stacks 100-1, 100-2, 100-3, and 100-4 may provide output using the first output based on a value obtained by dividing the required output by the first output being less than or equal to the number of the plurality of fuel cell stacks 100-1, 100-2, 100-3, and 100-4. The controller 500 may determine that the plurality of fuel cell stacks 100-1, 100-2, 100-3, and 100-4 may provide outputs using the second output based on a value obtained by dividing the required output by the second output being less than or equal to the number of the plurality of fuel cell stacks 100-1, 100-2, 100-3, and 100-4. A reason for performing such a determination process may be to determine a level at which the plurality of fuel cell stacks will be operated if the required output (indicated by/requested via the input) is handled by the plurality of fuel cell stacks equipped in the system.

For example, in an example of the present disclosure, the first output may be a middle level of output in an output range of the required output (e.g., the first output may be a value corresponding to 68 kW, which may represent the middle level), and the second output may be a high level of output in the output range of the required output (e.g., the second output may be a value corresponding to 80 kW, which may represent the high level). However, it should be understood that the above-described numerical values are examples, and the present disclosure is not necessarily limited thereto. If the first output is determined to be sufficient (S205), the second output may not need to be determined sufficient (S206 may not be performed)

Thereafter, the controller 500 may determine usage priority for the plurality of fuel cell stacks 100-1, 100-2, 100-3, and 100-4 and/or the at least one battery 300 (S208). The usage priority may be determined based on a result of determinations as to whether an output may be provided (S204, S205). For example, the controller 500 may determine whether to use the at least one battery 300 first and/or to use the plurality of fuel cell stacks 100-1, 100-2, 100-3, and 100-4 first in order to satisfy the required output based on the result of determination as to whether an output may be provided. Based on determining that all of the plurality of fuel cell stacks 100-1, 100-2, 100-3, and 100-4 and the at least one battery 300 may provide outputs (e.g., are able to provide sufficient output), the controller 500 according to an example of the present disclosure may determine usage priority so that the at least one battery 300 is used first before the plurality of fuel cell stacks 100-1, 100-2, 100-3, and 100-4. Also, or alternatively, the controller 500 may determine usage priority so that the at least one battery 300 is used first and then the plurality of fuel cell stacks 100-1, 100-2, 100-3, and 100-4 is used, but among the plurality of fuel cell stacks 100-1, 100-2, 100-3, and 100-4, a fuel cell stack capable of providing an output using the first output is preferentially used and a fuel cell stack capable of providing an output using only the second output is used later (e.g., at lower priority).

If the controller 500 determines usage priority so that the battery 300 is used first before the plurality of fuel cell stacks 100-1, 100-2, 100-3, and 100-4, it is possible to minimize/reduce unnecessary starting of the fuel cell stacks, and to minimize/reduce inefficient operation of the fuel cell stacks due to low output demand. Also, or alternatively, by distinguishing priorities according to outputs among the plurality of fuel cell stacks 100-1, 100-2, 100-3, and 100-4, efficient output may be possible for each fuel cell stack, so that it is possible to prevent/reduce/delay deterioration of durability performance of the fuel cell stacks.

The controller 500 may control the plurality of fuel cell stacks 100-1, 100-2, 100-3, and 100-4 and/or the at least one battery 300, selectively, to provide an output to satisfy the required output according to the determined usage priority. Hereinafter, a description will be given of control by the controller 500 in consideration of a result of determination as to whether the battery may provide an output (S204) and/or a result of determination as to whether the fuel cell stacks may provide an output (S207).

For example, the controller 500 may compare the required output with a dischargeable output of the at least one battery 300 to determine whether the required output is less than or equal to the dischargeable output of the at least one battery 300 (S209). If the at least one battery 300 may provide an output, and the required output is less than or equal to the dischargeable output of the battery (Yes in S209), the controller 500 may control the at least one battery 300 to provide an output to satisfy the required output (S210). In this instance, the controller 500 may control the plurality of fuel cell stacks 100-1, 100-2, 100-3, and 100-4 to not provide and/or suspend providing an output. In this way, it is possible to ensure durability performance of the fuel cell stacks by reducing unnecessary operation of an fuel cell stack(s) and/or achieve a high level of energy efficiency.

However, if the required output cannot be satisfied by the at least one battery 300, operation of a fuel cell stack may be necessary.

For example, if the required output exceeds the dischargeable output of the battery even though the at least one battery 300 may provide an output (No in S209), the controller 500 may determine whether the required output is less than or equal to a third output according to an output level (S211), and perform a control operation based on a determination result. In this instance, the third output according to the output level may refer to a lower output than the first and second outputs described above. For example, the third value may be a lower level of output in the output range of the required output (e.g., may be a value corresponding to 30 kW as a value representing the lower level of output). However, this value is an example, and the present disclosure is not necessarily limited thereto.

If the required output is less than or equal to the third output (Yes in S211), the controller 500 may further determine the SoC of the at least one battery 300 and control the plurality of fuel cell stacks 100-1, 100-2, 100-3, and 100-4 and/or the at least one battery 300 to provide an output. For example, if the required output is less than or equal to the third output (Yes in S211), the at least one battery 300 is determined to be able to provide an output (S204), and the SoC of the at least one battery 300 is greater than or equal to a second SoC (Yes in S212), then the controller 500 may determine that the required output may be handled only using the battery. The controller 500 may control the at least one battery 300 to provide an output (S210) based on the determining. The second SoC may be a value preset to correspond to a lower limit of the battery SoC. For example, the second SoC may be a value corresponding to 40% of the battery SoC. However, this is an example, and the present disclosure is not necessarily limited thereto.

However, even if the required output is less than or equal to the third output (Yes in S211), it may be difficult to handle the required output only using the at least one battery 300. For example, if the required output is less than or equal to the third output (Yes in S211), but the output of the at least one battery 300 is unavailable or the SoC of the at least one battery 300 is less than the second SoC (No in S212), the controller 500 may control the plurality of fuel cell stacks 100-1, 100-2, 100-3, and 100-4 to provide outputs (e.g., control one or more fuel cell stacks of the plurality of fuel cell stacks 100-1, 100-2, 100-3, and 100-4 to provide one or more outputs, herein). For example, the controller 500 may determine the total accumulated output amount of each of the plurality of fuel cell stacks 100-1, 100-2, 100-3, and 100-4, and control the plurality of fuel cell stacks 100-1, 100-2, 100-3, and 100-4 to provide outputs in descending order of the determined total accumulated output amount (S213). Since the required output requested/input from the outside is a low output less than or equal to the third output, performance (e.g., power output) required from the fuel cell stacks is likely to be significantly low. Accordingly, to satisfy the required output by first using an aged fuel cell stack and maintain durability performance of other fuel cell stacks at the same time, the controller 500 may determine the total accumulated output amount of each of the plurality of fuel cell stacks 100-1, 100-2, 100-3, and 100-4, and control so that outputs of the fuel cell stacks are provided in descending order of the total accumulated output amount. The total accumulated output amount refers to the total amount of energy generated by the fuel cell stacks from the beginning to the present, and may be regarded as an SoH in a long-term perspective of the fuel cell stacks. If the required output is low, the required output may be handled using a fuel cell stack having a low SoH, and in this way, it is possible to increase durability of a fuel cell stack having a high SoH.

Also, or alternatively, the controller 500 may control the plurality of fuel cell stacks 100-1, 100-2, 100-3, and 100-4 to provide an output to the outside and charge the at least one battery 300 (e.g., at the same time). By charging the battery and maintaining provision of the required output (e.g., at the same time), the battery will be enabled to provide an output in the future, so that it is possible to reduce unnecessary starting of the fuel cell stacks, thereby improving durability of the fuel cell stacks and achieving energy efficiency.

Meanwhile, if the required output exceeds the third output which is a low output, the controller 500 may control the plurality of fuel cell stacks 100-1, 100-2, 100-3, and 100-4 using a different strategy. For example, if the required output exceeds the third output (No in S211), the controller 500 may determine the SoC of the at least one battery 300 and the accumulated output amount (e.g., after starting) of each of the plurality of fuel cell stacks 100-1, 100-2, 100-3, and 100-4. Also, or alternatively, the controller 500 may control the at least one battery 300 to provide an output (S215) if the SoC of the at least one battery is greater than or equal to the first SoC preset to correspond to the upper limit of the battery SoC and the sum of the accumulated output amounts after starting of each of the plurality of fuel cell stacks 100-1, 100-2, 100-3, and 100-4 is greater than or equal to a preset reference accumulated output amount (Yes in S214). Also, or alternatively, the controller 500 may control the plurality of fuel cell stacks 100-1, 100-2, 100-3, and 100-4 to suspend providing an output from the plurality of fuel cell stacks 100-1, 100-2, 100-3, and 100-4. In this instance, the accumulated output amount after the fuel cell stacks are started may refer to short-term performance as accumulated power generation from the last start-up time. Therefore, power is provided to the outside only through the battery in a limited manner only if the external required output exceeds the third output which is a low output, the SoC of the battery is sufficient, and fatigue of the fuel cell stacks has accumulated in a short period of time.

Accordingly, even if a large amount of output is required (e.g., indicated by the input, requested, etc.) from the outside (e.g., an attached load to receive power), since the SoC of the battery 300 is sufficient, power is provided only using the battery 300, and operations of the plurality of fuel cell stacks 100-1, 100-2, 100-3, and 100-4 are suspended, thereby reducing operation of an unnecessary fuel cell stack, so that it is possible to ensure durability performance of the fuel cell stack and achieve a high level of energy efficiency.

If the output of the at least one battery 300 is unavailable (e.g., insufficient), the SoC of the at least one battery 300 is less than the first SoC, or the sum of the accumulated output amounts after starting of each of the plurality of fuel cell stacks 100-1, 100-2, 100-3, and 100-4 is less than the reference accumulated output amount (No in S214), the controller 500 may control the plurality of fuel cell stacks 100-1, 100-2, 100-3, and 100-4 to provide outputs. For example, the controller 500 may determine the accumulated output amount (e.g., after starting) of each of the plurality of fuel cell stacks 100-1, 100-2, 100-3, and 100-4 or the total accumulated output amount of each of the plurality of fuel cell stacks 100-1, 100-2, 100-3, and 100-4, and control the plurality of fuel cell stacks 100-1, 100-2, 100-3, and 100-4 to provide outputs in ascending order of the accumulated output amount after starting or total accumulated output amount (S216).

Since the SoC of the battery 300 is insufficient or the short-term fuel cell stack condition is expected to be favorable, the required output may be provided to the outside via the plurality of fuel cell stacks 100-1, 100-2, 100-3, and 100-4. Also, or alternatively, if only some of the plurality of fuel cell stacks 100-1, 100-2, 100-3, and 100-4 need to be operated, the controller 500 may select and operate one or more fuel cell stacks having the smallest accumulated output amount. That is, by selecting and utilizing a fuel cell stack having a favorable short-term SoH, the overall durability performance of the fuel cell stacks may be maintained. If there is a plurality of fuel cell stacks having the best short-term SoH, a fuel cell stack having a smaller total accumulated output amount among the fuel cell stacks may be operated first to provide an output to the outside. That is, by prioritizing short-term performance and utilizing a fuel cell stack having favorable long-term performance first if short-term performances are comparable, it may be possible to balance durability performances of the plurality of fuel cell stacks 100-1, 100-2, 100-3, and 100-4.

Also, or alternatively, the controller 500 may provide an output to the outside using an output of the plurality of fuel cell stacks 100-1, 100-2, 100-3, and 100-4 and charge the at least one battery 300 at the same time. In this way, by charging the battery while maintaining provision of the required output at the same time, the battery is enabled to provide an output in the future, so that it is possible to reduce unnecessary starting of the fuel cell stacks, thereby ensuring durability performance of the fuel cell stacks and achieving energy efficiency.

The controller 500 may control the plurality of fuel cell stacks 100-1, 100-2, 100-3 and/or 100-4 and/or the at least one battery 300 to provide an output to the outside according to a control strategy determined as described herein. The controller may also (e.g., at the same time) monitor (e.g., continuously and/or semi-continuously/periodically monitor) the states of the plurality of fuel cell stacks 100-1, 100-2, 100-3, and 100-4 and/or the at least one battery 300 (e.g., in real time and/or while controlling them) (S217). The controller 500 may re-examine the control strategy by re-determining the usage priority based on the monitoring (e.g., in real time or at regular intervals based on monitoring results).

Hereinafter, a description will be given of state changes of the fuel cell stacks and the battery to which the multi-module fuel cell system and the method of controlling the same according to an example of the present disclosure are applied with reference to FIG. 3 and FIG. 4.

FIG. 3 is a graph for describing an output flow of the multi-module fuel cell system according to an example of the present disclosure, and FIG. 4 is a graph for describing battery pre-charging of the multi-module fuel cell system according to an example of the present disclosure.

FIG. 3 shows an example in which the SoC of the battery 300 is less than the second SoC (SoC 2) at the beginning of time period A. SOC 2 is the lower limit of the battery 300 SoC. Accordingly, in section A, since the SoC of the battery 300 is less than the second SoC (SoC 2), which is the lower limit, the first fuel cell stack 100-1 among the plurality of fuel cell stacks 100-1, 100-2, 100-3, and 100-4 may generate power. The first fuel cell stack 100-1 may generate an output P1 to satisfy a required output input from the outside through power generation, and may provide an output to the outside using the output of P1 and charge the battery 300 at the same time. Accordingly, the SOC of the battery 300 may gradually increase in section A.

Also, or alternatively, in section B, even though the SoC of the battery 300 is greater than the second SoC (SoC 2), which is the lower limit of the SoC, it still may be difficult to satisfy the external required output with only the battery 300 (e.g., S214 No), and thus the output may continue to be provided via one or more of the plurality of fuel cell stacks 100-1, 100-2, 100-3, and 100-4. However, to balance durability performance between the fuel cell stacks, a control operation may be performed so that the second fuel cell stack 100-2 generates power, and the first fuel cell stack 100-1 power generation may be suspended. Thereafter, in section C, the first fuel cell stack 100-1 may be operated again, and the second fuel cell stack 100-2 power generation may be suspended.

Through sections A to C, the battery 300 may be charged by receiving an output from the fuel cell stack, and the SoC of the battery 300 may reach the first SoC (SoC 1), which is the upper limit of the SoC.

If the SoC of the battery 300 reaches the first SoC (SoC 1), power generation by all fuel cell stacks may be suspended and an output may be provided to the outside using only the battery 300 (e.g., S214 Yes). In this way, it is possible to ensure durability of the fuel cell stacks. As shown in section D, the controller 500 may control so that an output satisfying the required output may be provided using only the battery 300 until the SoC of the battery 300 reaches the second SoC (SoC 2).

If the SoC of the battery 300 reaches the second SoC (SoC 2), which is the lower limit, the first fuel cell stack 100-1 and/or the second fuel cell stack 100-2 may sequentially generate power as in sections E to F. FIG. 3 illustrates that the second fuel cell stack 100-2 first generates power and the first fuel cell stack 100-1 generates power later. However, this is only an example and the present disclosure is not necessarily limited thereto. The first fuel cell stack 100-1 may generate power first, and the second fuel cell stack 100-2 may generate power later. Also, or alternatively, if the SoC of the battery 300 reaches the first SoC (SoC 1) again as in section G, power supply to the outside is completed by using the battery 300. However, depending on the profile of the required output required from the outside, an output P2 of the battery 300 may be lower than an initial output P1 of the battery 300.

Also, or alternatively, for the battery 300, the output may correspond to performance related to SoC and/or temperature. Therefore, to discharge the desired output via the battery 300, SoC and temperature conditions of the battery 300 need to be satisfied first.

To this end, as illustrated in FIG. 4, by predicting changes in the required output over time, the SoC of the battery 300 may be increased (e.g., in advance of a predicted high output requirement), such as from section H before section J where a high output is required. By increasing the SoC of the battery 300 in advance (e.g., before a high output is required/requested), the temperature of the battery 300 may be increased in advance, and an output that may satisfy the required output may be provided without difficulty using only the battery 300 from section J where a high output is required.

The present disclosure is proposed to solve various problems of the related art. The present disclosure provides a multi-module fuel cell system, and a method of controlling the same, which extends lives of fuel cell stacks and enables efficient management of charging energy by efficiently controlling a plurality of fuel cell stacks and batteries.

The multi-module fuel cell system may include a plurality of fuel cell stacks, at least one battery connected to the plurality of fuel cell stacks, and a controller configured to determine whether the plurality of fuel cell stacks and the at least one battery are allowed to provide outputs in response to input of a required output. The controller may control either the plurality of fuel cell stacks and/or the at least one battery, selectively, to provide an output to satisfy the required output based on a result of determination as to whether outputs are allowed to be provided.

Also, or alternatively, a method of controlling a multi-module fuel cell system configured to provide outputs through a plurality of fuel cell stacks and at least one battery may include determining, by a controller, whether the plurality of fuel cell stacks and the at least one battery are allowed to provide outputs in response to input of a required output, and controlling, by the controller, either the plurality of fuel cell stacks or the at least one battery, selectively, to provide an output to satisfy the required output based on a result of determination as to whether outputs are allowed to be provided.

The multi-module fuel cell system and the method of controlling the same according to the present disclosure may extend/increase the lives of the fuel cell stacks and efficiently manage charging energy by efficiently controlling the fuel cell stacks and the battery.

Durability of the fuel cell stacks may be increased by evenly distributing a usage time of each module of the fuel cell system and minimizing unnecessary starting of the fuel cell stacks due to output priority use of the battery if a low output is required.

Also, or alternatively, or alternatively, by prioritizing charging/discharging after battery temperature rise if a low output is required and minimizing a low-efficiency operation section of the fuel cell stacks, efficient energy management is possible.

Even though the present disclosure has been illustrated and described with respect to specific examples thereof, it will be apparent to those skilled in the art that the present disclosure may be variously improved and modified without departing from the technical spirit of the present disclosure as defined by the claims below.

Furthermore, the term related to a control device such as “controller”, “control apparatus”, “control unit”, “control device”, “control module”, or “server”, etc., refers to a hardware device including a memory and a processor configured to execute one or more steps interpreted as an algorithm structure. The memory stores algorithm steps, and the processor executes the algorithm steps to perform one or more processes of a method in accordance with various examples of the present disclosure. The control device according to examples of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various examples of the present disclosure.

The aforementioned disclosure can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM) , random-access memory (RAM), CD-ROMs, magnetic tapes, floppy discs, optical data storage devices, etc. and implementation as carrier waves (e.g., transmission over the Internet). Examples of the program instruction include machine language code such as those generated by a compiler, as well as high-level language code which may be executed by a computer using an interpreter or the like.

In various examples of the present disclosure, each operation described above may be performed by a control device, and the control device may be configured by a plurality of control devices, or an integrated single control device.

In various examples of the present disclosure, the memory and the processor may be provided as one chip, or provided as separate chips.

In various examples of the present disclosure, the scope of the present disclosure includes software or machine-executable commands (e.g., an operating system, an application, firmware, a program, etc.) for enabling operations according to the methods of various examples to be executed on an apparatus or a computer, a non-transitory computer-readable medium including such software or commands stored thereon and executable on the apparatus or the computer.

In various examples of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the examples with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In examples of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the example of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific examples of the present disclosure have been presented for purposes of illustration and description. They are not intended to be exhaustive or to limit the present disclosure to the precise forms disclosed, and obviously many modifications and variations are possible in light of the above teachings. The examples were chosen and described in order to explain certain principles of the disclosure and their practical application, to enable others skilled in the art to make and utilize various examples of the present disclosure, as well as various alternatives and modifications thereof. It is intended that the scope of the present disclosure be defined by the Claims appended hereto and their equivalents.

What is claimed is:

1. A multi-module fuel cell system comprising:
a plurality of fuel cell stacks;
at least one battery connected to the plurality of fuel cell stacks; and
a controller configured to:
determine, based on input indicating a requested power output and based on at least one of a state of charge (SoC) of the at least one battery or a number of fuel cell stacks in the plurality of fuel cell stacks, one or more of the plurality of fuel cell stacks or the at least one battery allowed to provide power output and
selectively control, based on the determined one or more of the plurality of fuel cell stacks or the at least one battery allowed to provide power output, either at least one fuel stack of the plurality of fuel cell stacks or the at least one battery to output power to satisfy the requested power output.

2. The multi-module fuel cell system of claim 1, wherein the controller is further configured to:
compare, based on the input, the SoC of the at least one battery with a first SoC preset to correspond to an upper limit of a battery SoC ; and
determine, based on the comparison, the one or more of the plurality of fuel cell stacks or the at least one battery allowed to provide output.

3. The multi-module fuel cell system of claim 2, wherein, the controller is configured to, based on the SoC of the at least one battery exceeding the first SoC, determine whether the at least one battery is allowed to provide power output, wherein the determination of whether the at least one battery is allowed is based on:
a number of the at least one battery,
the requested power output, and
at least one of:
available output information of the at least one battery,
temperature information of the at least one battery, or
SoC information of the at least one battery.

4. The multi-module fuel cell system of claim 3, wherein, the controller is configured to, based on the SoC of the at least one battery being less than or equal to the first SoC, determine whether the plurality of fuel cell stacks are allowed to provide power output, wherein whether the determination of the plurality of fuel cell stacks are allowed is based on:
a first output according to an output level,
a second output greater than the first output,
a number of the plurality of fuel cell stacks, and
the requested power output.

5. The multi-module fuel cell system of claim 4, wherein the controller is configured to:
determine that the plurality of fuel cell stacks are allowed to provide power output using the first output based on a value obtained by dividing the requested power output by the first output being less than or equal to the number of the plurality of fuel cell stacks; and
determine that the plurality of fuel cell stacks are allowed to provide power output using the first output based on a value obtained by dividing the requested power output by the second output being less than or equal to the number of the plurality of fuel cell stacks.

6. The multi-module fuel cell system of claim 1, wherein the controller is configured to:
determine, based on the determined one or more of the plurality of fuel cell stacks or the at least one battery, a usage priority for the plurality of fuel cell stacks and the at least one battery; and
selectively control, based on the determined usage priority, either the plurality of fuel cell stacks or the at least one battery to satisfy the requested power output.

7. The multi-module fuel cell system of claim 1, wherein the controller is configured to:
determine whether the requested power output is less than or equal to a dischargeable output available from the at least one battery; and
control, based on determining the at least one battery is allowed to provide power output and based on the requested power output being less than or equal to the dischargeable output, the at least one battery to output power to satisfy the requested power output.

8. The multi-module fuel cell system of claim 1, wherein the controller is configured to:
determine, based on the at least one battery being allowed to provide power output and based on the requested power output exceeding a dischargeable output available from the at least one battery, whether the requested power output is less than or equal to a third output associated with an output level; and
determine, based on the requested power output being less than or equal to the third output, an SoC of the at least one battery.

9. The multi-module fuel cell system of claim 8, wherein the controller is configured to control, based on the requested power output being less than or equal to the third output and based on the SoC of the at least one battery being greater than or equal to a second SoC preset to correspond to a lower limit of a battery SoC, the at least one battery to output the power.

10. The multi-module fuel cell system of claim 8, wherein the controller is configured to:
determine, based on the requested power output being less than or equal to the third output, and an output of the at least one battery being unavailable or the SoC of the at least one battery being less a second SoC preset to correspond to a lower limit of a battery SoC, total accumulated output amounts of the plurality of fuel cell stacks, and
control the plurality of fuel cell stacks to provide power outputs in descending order of the determined total accumulated output amounts.

11. The multi-module fuel cell system of claim 8, wherein the controller is configured to:
determine, based on the requested power output exceeding the third output, the SoC of the at least one battery and accumulated output amounts of the plurality of fuel cell stacks; and
control, based on the SoC of the at least one battery being greater than or equal to a first SoC preset to correspond to an upper limit of a battery SoC and based on a sum of the accumulated output amounts being greater than or equal to a preset reference accumulated output amount, the at least one battery to output power.

12. The multi-module fuel cell system of claim 8, wherein the controller is configured to, based on at least one of:
an output of the at least one battery being unavailable,
the SoC of the at least one battery being less than a first SoC preset to correspond to an upper limit of a battery SoC, or
a sum of accumulated output amounts of the plurality of fuel cell stacks being less than a preset reference accumulated output amount,
control the plurality of fuel cell stacks to output power in ascending order of an accumulated output amount, of each of the plurality of fuel cell stacks, after starting the plurality of fuel cell stacks or a total accumulated output amount of each of the plurality of fuel cell stacks.

13. A method of controlling a multi-module fuel cell system comprising a plurality of fuel cell stacks and at least one battery, the method comprising:
determining, by a controller of the multi-module fuel cell system and based on input indicating a requested power output and based on at least one of a state of charge (SoC) of the at least one battery or a number of fuel cell stacks in the plurality of fuel cell stacks, one or more of the plurality of fuel cell stacks or the at least one battery allowed to provide power output; and
selectively controlling, by the controller and based on the determined one or more of the plurality of fuel cell stacks or the at least one battery allowed to provide power output, either at least one fuel cell stack of the plurality of fuel cell stacks or the at least one battery to output power to satisfy the requested power output.

14. The method of claim 13, wherein the determining the one or more of the plurality of fuel cell stacks or the at least one battery allowed to provide power output is further based on:
comparing, by the controller, the SoC of the at least one battery with a first SoC preset to correspond to an upper limit of a battery SoC.

15. The method of claim 13, wherein, based on the SoC of the at least one battery exceeding a first SoC corresponding to an upper limit of a battery SoC, the determining the one or more of the plurality of fuel cell stacks or the at least one battery allowed to provide power output is further based on a number of the at least one battery, the requested power output, and at least one of:
available output information of the at least one battery,
temperature information of the at least one battery, or
SoC information of the at least one battery.

16. The method of claim 13, wherein, based on the SoC of the at least one battery being less than or equal to a first SoC corresponding to an upper limit of a battery SoC, the determining the one or more of the plurality of fuel cell stacks or the at least one battery allowed to provide power output is further based on a first output according to an output level, a second output greater than the first output, a number of the plurality of fuel cell stacks, and the requested power output.

17. The method of claim 13, wherein the selectively controlling is based on a usage priority, for the plurality of fuel cell stacks and the at least one battery, determined, by the controller, based on the determined one or more of the plurality of fuel cell stacks or the at least one battery.

18. A multi-module fuel cell system comprising:
a plurality of fuel cell stacks;
at least one battery; and
a controller comprising:
one or more processors; and
a memory storing instructions that, when executed by the one or more processors, configure the controller to:
monitor:
a state of charge (SoC) of the at least one battery; and
accumulated amounts of power output of each fuel cell stack of the plurality of fuel cell stacks;
receive a request for power; and
control, based on the request and whether the monitored SoC satisfies a SoC criterion, either:
a fuel cell stack, of the plurality of fuel cell stacks and based on a corresponding accumulated amount of the monitored accumulated amounts, to satisfy the request; or
the at least one battery to satisfy the request.

19. The multi-module fuel cell system of claim 18, wherein the instructions, when executed by the one or more processors, configure the controller to control, based on the monitored SoC not satisfying the SoC criterion, the fuel cell stack to satisfy the request and one or more fuel cell stacks, of the plurality of fuel cell stacks, to charge the at least one battery.

20. The multi-module fuel cell system of claim 18, wherein the instructions, when executed by the one or more processors, configure the controller to determine, based on the accumulated amounts, a usage priority of the plurality of fuel cell stacks, and wherein the controlled fuel cell stack is based on the usage priority.
